(19) United States
(12) Patent Application Publication
(10) Pub. No.: US 2008/0084312 A1
(43) Pub. Date: Apr. 10, 2008

(54) RADIO FREQUENCY IDENTIFICATION LAYERED FOAM TAG

(76) Inventor: Michael A. Daily, Claremont, NC (US)

Correspondence Address: SNELL & WILMER LLP (OC), 600 ANTON BOULEVARD, SUITE 1400, COSTA MESA, CA, 92626, US

(21) Appl. No.: 11/869,550

(22) Filed: Oct. 9, 2007

Related U.S. Application Data
(60) Provisional application No. 60/850,619, filed on Oct. 10, 2006.

(51) Int. Cl. H04B 7/00

(52) U.S. Cl. 340/572.8

(57) ABSTRACT

The manufacturer and use of an radio frequency identification (RFID) tag includes an improved foam substrate that is fire-resistant that utilizes an adhesive that allows the use of the tag in hot and cold environments without regard to the dielectric constant of the surface of the product that the tag is affixed. The sensitivity of the tag is sufficiently maintained to allow the trimming of the antenna when it is desirable to reduce the size of the affixed RFID tag.

### CLAIM OF PRIORITY UNDER 35 U.S.C. §119

The present application for patent claims priority to Provisional Application No. 60/850,619 entitled “CONVERTED RFID TAG,” filed Oct. 9, 2006 and assigned to the assignee hereof and hereby expressly incorporated by reference herein.

### BACKGROUND

1. Field

The invention relates generally to radio frequency identification (RFID) tags. More particularly, the invention relates to an RFID layered foam tag.

2. Related Art

Radio Frequency Identification (RFID) tags are well known in the art. RFID tags include an antenna and an RFID chip which rectifies an incoming signal from a reader and a means to reflect through the antenna a modulated signal to the reader. RFID tags may be affixed to products having a wide range of dielectric constants caused by the type of packaging and the contents of the packaging which can alter its sensitivity. It is desirable for RFID tags to have predictable sensitivity. The sensitivity of the RFID tag has a direct correlation to the maximum distance between the reader and the RFID tag that can exist while maintaining the ability to successfully read the RFID tag.

Packaging that holds very cold items has a different sensitivity to packaging that holds very hot items. For example, an RFID tag placed on an ice cream container will have a different sensitivity than an RFID tag placed on a hot chicken container.

Thus, there is a need for an RFID tag that has minimal sensitivity to temperature changes of the packaging of the product with the RFID tag.

### SUMMARY

A radio frequency identification (RFID) layered tag comprising a facing layer, an inlay web layer attached via a first adhesive layer to the facing layer, an RFID chip and an antenna embedded into the inlay web layer, a polylactic acid foam layer attached via a second adhesive layer to the inlay web layer, and a third adhesive attached to the polylactic acid foam layer for attachment to an object.

### BRIEF DESCRIPTION OF THE DRAWINGS

FIG. 1 is a side view of an RFID layered foam tag where the layers are separated to better illustrate each layer according to an embodiment of the invention.

### DETAILED DESCRIPTION

Apparatus, systems and methods that implement the embodiments of the various features of the present invention will now be described with reference to the drawings. The drawings and the associated descriptions are provided to illustrate some embodiments of the invention and not to limit the scope of the present invention. Throughout the drawings, reference numbers are re-used to indicate correspondence between referenced elements. In addition, the first digit of each reference number indicates the figure in which the element first appears.

The present invention provides an improved RFID layered foam tag with good sensitivity without regard to the type of material of the container or contents of the container that the RFID tag is attached. Many RFID tags in the art can be shorted out or made inoperative because of the surface material or contents of the container that the RFID tag is affixed. By way of example, squiggle RFID tags known in the art manufactured by Alien Technology and Avery Dennison Corporation are preferable because of their unit cost. However, these RFID tags can be shorted out when affixed to foil or containers containing liquid. The present invention solves previous problems by raising RFID tags from the surface of the container by use of a foam layer.

The present invention provides an improved RFID tag that limits or avoids combustion when the RFID tag is subjected to a microwave oven. A passive RFID tag includes a transponder and an antenna. The transponder transmits information when a RFID reader transmits radio waves that are received by the antenna. However, when subjected to radio waves from a microwave oven, the RFID tag can combust. This situation can be exasperated when the RFID tag is mounted on combustible material such as foam rubber. The present invention solves this problem by mounting the RFID tag upon a noncombustible layer or substrate.

The present invention provides an improved RFID tag that is reduced in size when compared to prior art RFID tags. The improved RFID tag is capable of being affixed to objects maintained at very hot or very cold temperatures. Previously known RFID tags were incapable of being attached to foil containers as are used in wrapping ice cream products. The present invention solves this problem with the combination of specialized foam and adhesives.

In view of these objects, as well as others, the present invention provides a RFID tag mounted upon noncombustible biodegradable foam with an adhesive that operates at high or low temperatures. The RFID tag can include a facing layer, an inlay web layer, a fire-resistant biodegradable foam layer, and a release liner layer. Between each of these layers is a layer of adhesive.

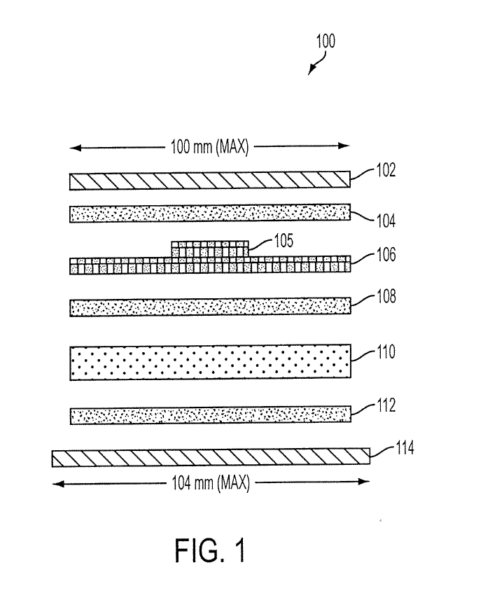

FIG. 1 is a side view of an RFID layered foam tag 100 where the layers are separated to better illustrate each layer according to an embodiment of the invention. The layers are affixed together using adhesive layers to form the RFID layered foam tag 100. The RFID layered foam tag 100 may include a facing layer 102, first, second, and third adhesive layers 104, 108, and 112, an RFID tag 105, an inlay web layer 106, a foam layer 110, and a release liner 114. In one embodiment, the layers have a maximum width of about 100 millimeters (mm).

The facing layer 102 is made of a thermal transfer printable white semi-gloss 60 pound biaxially oriented polypropylene (BOPP) material. Examples of the facing layer 102 include Rayoface manufactured by Innovia Films Ltd. or PLA Foam manufactured by Kuwata. In one embodiment, the facing layer 102 is between about 1 mm and about 3 mm thick and preferably about 2 mm thick.

The RFID tag 105 may include an RFID chip and an antenna. The RFID tag 105 may be positioned on the inlay web layer 106 or embedded in the inlay web layer 106. The RFID chip may be attached to the inlay web layer 106 via various methods such as Alien's FSA (Fluid Self Assembly). The antenna may be a printed silver or copper antenna and may be attached to the RFID chip via a strap and glue. The RFID tag 105 and the inlay web layer 106 are preferably item number squiggle manufactured by Alien Technology or item number AD-222 manufactured by Avery Dennison Corporation; however, it should be appreciated that other similarly functioning RFID tag 105 and inlay web layer 106 may be used. The assembly is typically referred to as an inlay and if an adhesive is part of the inlay, the term “wet adhesive” is used and if no adhesive is used, the term “dry inlay” is used.

The foam layer 110 is made of an improved foam material that is noncombustible (e.g., fire-resistant) and biodegradable, allows use in hot and cold environments, and provides sufficient sensitivity without regard to the dielectric constant of the surface of the product that the RFID layered foam tag is affixed to allowing the actual tag to be reduced in size. The foam layer 110 may be a fire-resistant biodegradable foam layer such as a polylactic acid foam layer that is between about 2.75 mm and about 3.50 mm thick and preferably about 3.175 mm thick. An example of the foam layer 110 is Volara manufactured by Reilly Foam.

The first adhesive layer 104 is used to attach the facing layer 102 to the RFID tag 105 and/or the inlay web layer 106. The second adhesive layer 108 is used to attach the RFID tag 105 and/or the inlay web layer 106 to the foam layer 110. The third adhesive layer 112 is used to attach the foam layer 110 to the release liner 114. The first, second, and third adhesive layers 104, 108, and 112 allow use with products subject to cold and hot environments. In one embodiment, the first, second, and third adhesive layers 104, 108, and 112 are made of a Wausau S590 material manufactured by Wausau Coated Products.

The release liner 114 is made of a Wausau 53# medium release liner paper. The release liner 114 can be pealed off so that the adhesive layer 112 can be attached to a product or packaging of a product.

The RFID layered foam tag 100 provides improved sensitivity and can be die-cut to reduce the size of the tag when the user finds it would be beneficial to have a reduced sized tag while maintaining a suitable sensitivity. The die-cut length may be between about 11 mm to about 15 mm. The RFID layered foam tag 100 (i.e., all the layers) can withstand extremely low temperatures (e.g., being placed in a freezer for an extended period of time) and extremely high temperatures (e.g., being placed in an over or microwave) without damage or degradation of the performance of the RFID chip and the antenna. Furthermore, the arrangement of the layers and the type of each layer has been selected to enhance performance and reduce size of the RFID layered foam tag 100.

The previous description of the disclosed embodiments is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A radio frequency identification (RFID) layered tag comprising:
a facing layer;
an inlay web layer attached via a first adhesive layer to the facing layer;
an RFID chip and an antenna embedded into the inlay web layer;
a polylactic acid foam layer attached via a second adhesive layer to the inlay web layer; and
a third adhesive layer attached to the polylactic acid foam layer for attachment to an object.

2. The RFID layered tag of claim 1 wherein the polylactic acid foam layer has a thickness of between about 2.75 mm and about 3.50 mm.

3. The RFID layered tag of claim 1 wherein the polylactic acid foam layer is made of a noncombustible material.

4. The RFID layered tag of claim 1 wherein the polylactic acid foam layer is made of a biodegradable material.

5. The RFID layered tag of claim 1 wherein the facing layer is made of a thermal transfer printable white semi-gloss biaxially oriented polypropylene material.

6. The RFID layered tag of claim 1 wherein the first, second, and third adhesive layers are made of a Wausau material.

7. The RFID layered tag of claim 1 wherein the facing layer has a thickness of between about 1 mm and about 3 mm.

8. A radio frequency identification (RFID) layered tag comprising:
a facing layer made of a biaxially oriented polypropylene material;
a first adhesive layer attached to the facing layer;
an RFID device and an antenna positioned adjacent to the first adhesive layer;
an inlay layer positioned adjacent to the RFID device;
a noncombustible foam layer attached via a second adhesive layer to the inlay layer; and
a third adhesive layer attached to the noncombustible foam layer for attachment to an object.

9. The RFID layered tag of claim 8 wherein the noncombustible foam layer has a thickness of between about 2.75 mm and about 3.50 mm.

10. The RFID layered tag of claim 8 wherein the noncombustible foam layer is a polylactic acid foam layer.

11. The RFID layered tag of claim 8 wherein the noncombustible foam layer is made of a biodegradable material.

12. The RFID layered tag of claim 8 wherein the first, second, and third adhesive layers are made of a Wausau material.

13. The RFID layered tag of claim 8 wherein the facing layer has a thickness of between about 1 mm and about 3 mm.

14. A radio frequency identification (RFID) layered tag comprising:
a facing layer;
a first adhesive layer attached to the facing layer;
an RFID chip;
an inlay layer attached to the RFID chip and the first adhesive layer;
a second adhesive layer attached to the inlay layer;
a noncombustible biodegradable foam layer attached to the second adhesive layer; and
a third adhesive layer attached to the noncombustible biodegradable foam layer.

15. The RFID layered tag of claim 14 wherein the noncombustible biodegradable foam layer has a thickness of between about 2.75 mm and about 3.50 mm.

16. The RFID layered tag of claim 14 wherein the noncombustible biodegradable foam layer is made of a polylactic acid material.

17. The RFID layered tag of claim 14 wherein the facing layer is made of a thermal transfer printable white semi-gloss material.

18. The RFID layered tag of claim 14 wherein the facing layer is made of a biaxially oriented polypropylene material.

19. The RFID layered tag of claim 14 wherein the first, second, and third adhesive layers are made of a Wausau material.

20. The RFID layered tag of claim 14 wherein the facing layer has a thickness of between about 1 mm and about 3 mm.
